(19) United States
(12) Patent Application Publication
(10) Pub. No.: US 2005/0200747 A1
(43) Pub. Date: Sep. 15, 2005

(54) Front case of image photographing apparatus

(75) Inventor: Kwang-Hyok Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/048,926

(22) Filed: Feb. 3, 2005

(30) Foreign Application Priority Data
Mar. 10, 2004 (KR) 2004-16025

(51) Int. Cl. H04N 5/225

(52) U.S. Cl. 348/373

(57) ABSTRACT

A front case of an image photographing apparatus has two lenses fixed on one side of a main body case so that the entire apparatus is minimized in size. The front case of the image photographing apparatus has a main body case receiving a first camera part having a first lens for photographing a moving image and a second camera part having a second lens for photographing a still image. The front case also includes a housing assembled to a front side of the main body case, and first and second holes formed on the housing front side to expose one of the first lens and second lens.

### CROSS-REFERENCE TO RELATED APPLICATIONS

This application claims the benefit under 35 U.S.C. § 119(a) of Korean Patent Application No. 2004-16025, entitled “Front Case of Image Photographing Apparatus,” filed on Mar. 10, 2004, the entire disclosure of which is hereby incorporated by reference.

### BACKGROUND OF THE INVENTION

1. Field of the Invention

The present invention relates to an image photographing apparatus capable of photographing moving or still images through separate lenses. More particularly, the present invention relates to a front case of an image photographing apparatus of which the entire apparatus is minimized in size by fixing two lenses on a main body case.

2. Description of the Related Art

Generally, an image photographing apparatus is mainly divided into a camera for photographing a still image and a camcorder for photographing moving images. The camera and camcorder have been separately developed and sold based on their own functional characteristics. Accordingly, a user has to buy both a camera and camcorder, respectively, if photographing both still and moving images is desired. If the user wishes to photograph a still image, the user should use a camera, and if the user wishes to photograph a moving image, the user should use a camcorder. In other words, a user must buy a separate apparatus depending on the desired medium. Consequently, not only is it cumbersome to carry both a camera and a camcorder, it is expensive to purchase both apparatuses.

To overcome the aforementioned drawbacks, as shown in FIG. 1, preferred embodiments of the present invention integrally combine both a camera and camcorder.

Referring to FIG. 1, a conventional image photographing apparatus comprises a main body 10 on which a tape cassette for recording moving and still images and a flash memory are detachably mounted. Camera unit 20 has a camcorder part for photographing moving images and a camera part for photographing still images. A display device is provided for displaying a moving or still image photographed through the camera unit 20. A control part is also provided for controlling each part to selectively photograph a moving image or a still image.

The main body 10 has a camera unit 20 comprising a housing 21 hingedly formed on one side of the main body 10, a camcorder part 30, and a camera part formed on the housing 21. Additionally, a lens 23 of the camcorder part and a lens (not shown) of the camera part are arranged on opposite sides of the main body 10. More specifically, the lens of camcorder part for photographing a moving image and the lens of camera part for photographing a still image are arranged on the housing 21 substantially about 180 degrees apart from one another. A mode sensor is formed between the main body 10 and the housing 21 for sensing rotation of housing 21 to recognize the selected lens. The control part can determine whether the camera part lens faces the front side or the camcorder part lens faces the front side, through the mode sensor. Accordingly, a user can select one of the camera and the camcorder by rotating the housing 21 to the main body 10 by 180 degrees in the direction of an arrow as shown in FIG. 1. Therefore, the user can photograph a still or moving image according to the selection. If the image photographing apparatus is applied, a user can buy and carry only one apparatus to photograph both still and moving images of high quality.

However, in the conventionally integral image photographing apparatus, a user must rotate the housing 21 by 180 degrees to select and use one of the camcorder part or the camera part, and therefore, operability deteriorates and the minimization of size is limited.

Accordingly, there is a need for an image photographing apparatus capable of photographing moving or still images of which the entire apparatus is minimized in size by fixing two lenses on a main body case.

### SUMMARY OF THE INVENTION

An aspect of the present invention is to solve at least the above problems and/or disadvantages and to provide at least the advantages described below. Accordingly, an aspect of the present invention is to provide a front case of an image photographing apparatus having a lens for camera and a lens for camcorder facing the same direction, and the front case can be integrally attached to a front side of a main body case, such that the image photographing apparatus can be compact-sized.

In order to achieve the above aspects, there is provided a front case of an image photographing apparatus which has a main body case receiving a first camera part having a first lens for photographing a moving image and a second camera part having a second lens for photographing a still image. The front case comprises a housing assembled to a front side of the main body case. A first hole and a second hole are formed on the housing front side to expose the first lens and second lens.

It is also preferable that first and second lens hoods are provided for assembly to the first and second holes, respectively.

It is also preferable that the first lens may be exposed through the first hole, and the second lens may be exposed through the second hole, and the first lens hood may further comprise a hood holder.

It is also preferable that a sensor receiving part is formed between the first hole and the second hole on the front side of the housing.

In further accordance with the purposes of the invention a blocking board is located on the sensor receiving part of the housing to cover the sensor receiving part. The sensor receiving part may be arranged to house an infrared ray LED, an illumination sensor, an auxiliary illumination LED and a remote control sensor.

Also in accordance with the purposes of the invention there is provided a jack cover that is openly formed on one side of the housing to expose a jack installed on the housing.

Other objects, advantages, and salient features of the invention will become apparent to those skilled in the art from the following detailed description, which, taken in conjunction with the annexed drawings, discloses preferred embodiments of the invention.

### BRIEF DESCRIPTION OF THE DRAWINGS

The above and other objects, and features, and advantages of certain embodiments of the present invention will be more apparent from the following description taken in conjunction with the accompanying drawings, in which:

FIG. 1 is a perspective view of a conventional image photographing apparatus;

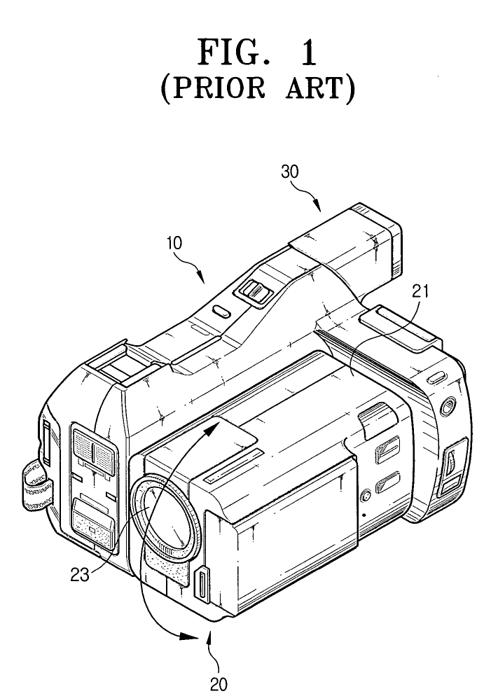

FIG. 2 is an elevation of a front case of an image photographing apparatus in accordance with an embodiment of the present invention;

FIG. 3 is an exploded perspective view of the front case of the image photographing apparatus shown in FIG. 2;

FIG. 4 is a perspective view of the front case assembled to a main body case of the image photographing apparatus shown in FIG. 2; and

FIG. 5 is a perspective view of an example of the image photographing apparatus shown in FIG. 2 assembled by the front case.

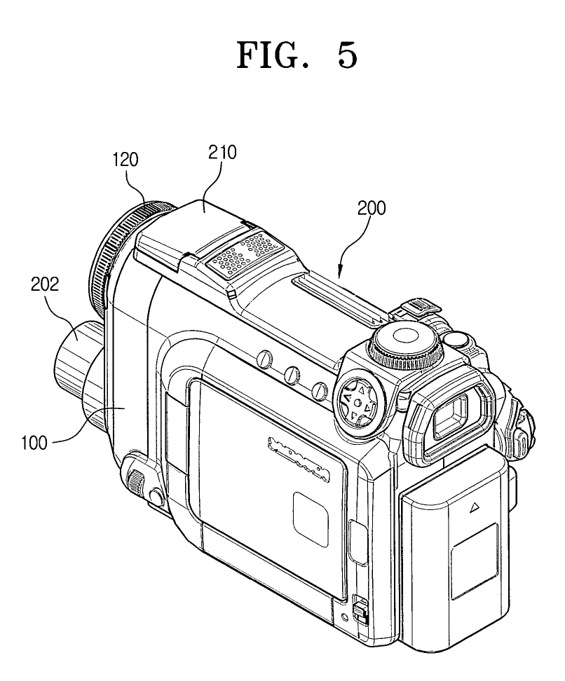

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of certain embodiments of the invention. Accordingly, those of ordinary skill in the art will recognize that various changes and modifications of the embodiments described herein can be made without departing from the scope and spirit of the invention. Also, descriptions of well-known functions and constructions are omitted for conciseness.

A front case 100 of an image photographing apparatus according to an embodiment of the present invention comprises a housing 110 assembled to a main body case 200. Two holes 111, 112 are formed on the front side 110a of the housing 110 and are spaced by a predetermined distance. The housing 110 may be formed in various shapes in accordance with the shape of the main body case 200 and the two holes 111, 112 may be formed in diverse shapes according to the lens sizes used.

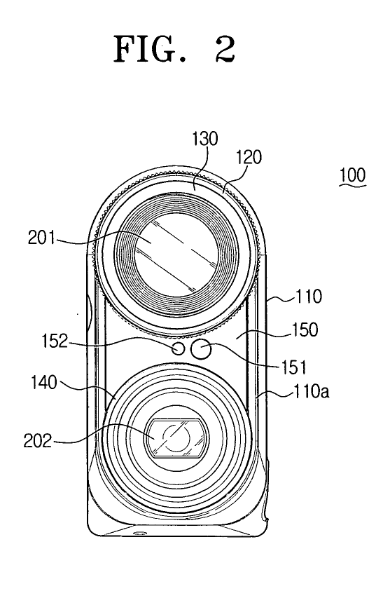

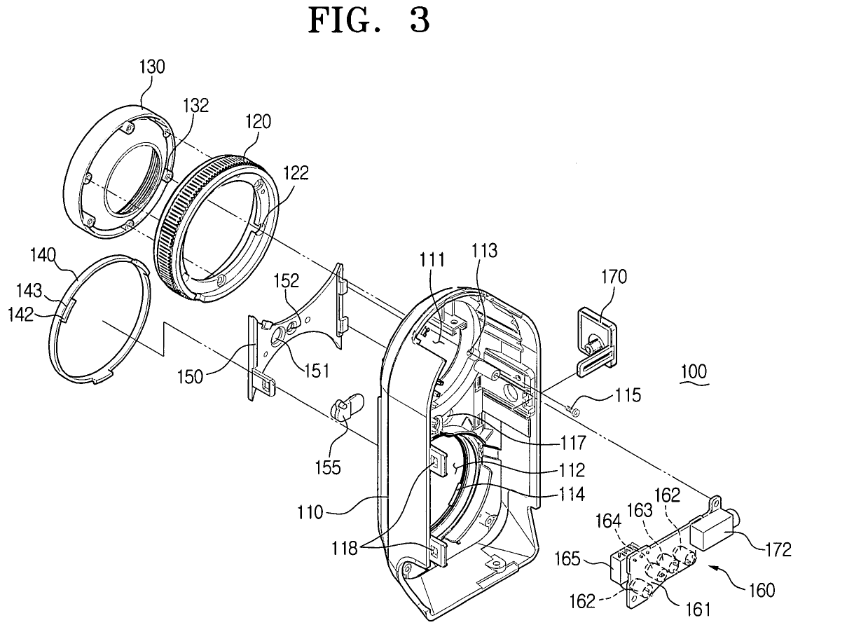

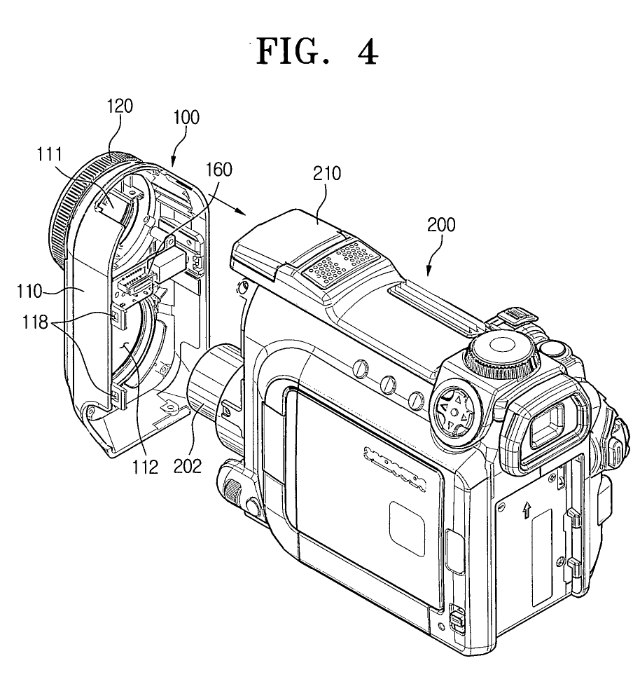

FIG. 2 and FIG. 3 are views of the front case 100 of the image photographing apparatus according to an embodiment of the present invention, and FIG. 4 is a perspective view of the front case 100 assembled to a main body case 200 of the image photographing apparatus as shown in FIG. 2.

Referring to FIGS. 2-4, the front case 100 comprises a housing 110 assembled to a main body case 200 of the image photographing apparatus. A first hole 111 and a second hole 112 are formed on the front side 110a of the housing 110 and are spaced by a predetermined distance.

The housing 110 is preferably formed in the shape of a hollow receptacle having a substantially squared front side 110a by injection molding. A first hole 111 and a second hole 112 are arranged on the front side 110a of the housing 110.

The first hole 111 is preferably formed so the first lens hood 120 may be assembled in a such a way that the front lens hood 120 corresponds to the first lens 201, and the lens is preferably for a camcorder that photographs a moving image. The first lens hood 120 is fixed over the first hole 111 of the housing 110 by a hood holder 130. Referring to FIG. 3, a plurality of bolt holes 113 are formed along the first hole 111 of the housing 110. The bolt holes are for fixing the hood holder 130. A plurality of taps 132 are formed along the hood holder 130, and the taps correspond to a plurality of bolt holes 113. A plurality of holes 122 are formed along the first lens hood 120 and the holes correspond to a plurality of taps 132 in such a manner that the holes can expose the plurality of taps 132 of the hood holder 130. Accordingly, after the first lens hood 120 is inserted in the hood holder 130 and connected by bolts 115 through the bolt holes 113 along the first hole 111, the first lens hood 120 may be fixed to the housing 110 of the front case 100. The hood holder 130 and bolt 115 are exemplary and are merely used to describe the structure for fixing the first lens hood 120 to the housing 110; however, it should be understood that other suitable structures and arrangements may be applied.

The second hole 112 is preferably formed so that the second lens hood 140 may be assembled in a manner so that the second lens hood 140 corresponds to the second lens 202 for a camera photographing a still image. A plurality of projection parts 114 extend into the second hole 112 so that the second lens hood 140 may be fixed. Three projection parts are arranged in relation to each other, preferably by about 120 degrees. A plurality of fixing parts 142 extend along the cylindrical surface of the second lens hood 140 in the direction of insertion to the second hole 112. The size of fixing parts 142 corresponds to the spacing between a plurality of projection parts 114 along the second hole 114. A fixing groove 143 is formed at each outer circumference of a plurality of fixing parts 142 to receive the projection parts 114 of the second hole 112. After the fixing parts 142 of the second lens hood 140 are inserted between the projection part 114 of the housing, and the second lens hood 140 is rotated in a certain direction, the projection part 114 of the second hole 112 is inserted in the fixing groove 143 of the fixing parts 142 of the second lens hood 140. Thus, the second lens hood 140 may be fixed to the front case 100. The fixing groove 143 and the projection part 114 are exemplary and are merely used to describe the structure for fixing the second lens hood 140, however, it should be understood that any other suitable conventional structures and arrangements may be used to connect or fasten the second lens hood 140 to the housing 110.

A sensor receiving part 117 is formed between the first hole 111 and the second hole 112 on the housing front side 110a. The sensor receiving part 117 receives a sensor used for the image photographing apparatus. The sensor receiving part 117 is preferably formed in a shape of a penetrating hole in alignment with the number and size of a plurality of sensors used for the image photographing apparatus. According to the present embodiment, a sensor assembly 160 comprises two infrared ray LEDs 162, an illumination sensor 163, an auxiliary illumination LED 164, and a remote control sensor 165 on one circuit board 161 with suitable spacing. If the circuit board 161 of the sensor assembly 160 is fixed on the housing 110, each sensor and each LEDs 161, 163, 164 and 165 may be operated so as to radiate through the penetrating hole of the sensor receiving part 117 on the housing front side 110a. A blocking board 150 is attached to the housing front side 110a and is in alignment with the sensor receiving part 114 of the housing 110 to cover the penetrating hole of the sensor receiving part 117. The blocking board 150 preferably is made of an opaque plastic so as not to show the sensor and LEDs 162, 163, 164 and 165 of the sensor assembly 160. However, any suitable conventional plastic capable of filtering infrared rays may be used. Penetrating holes 151 and 152 are preferably formed on the blocking board 150 in alignment with the auxiliary illumination LED 164 and the illumination sensor 163 so as not to obstruct emission of the light from the auxiliary illumination LED 164 and the illumination sensor 163. A transparent window is preferably formed in the penetrating holes of the blocking board 150 and the housing 110 to support movement of the auxiliary illumination LED 164 and the illumination sensor 163.

As shown in FIG. 4, a plurality of connecting parts 118 are formed at the rear part of the housing 110 to attach the front case 100 to the fixing end 210 of the main body case 200. The upper side of the housing 110 is partially removed to receive flash 210.

A microphone jack or earphone jack 172 may be selectively mounted on the housing 110. A jack cover 170 is openly disposed on one side of the housing 110 to expose the connecting part of the jack 172. Accordingly, when a user uses the jack 172, the user opens the jack cover 170 to connect a microphone (not shown) or a earphone (not shown) to the jack 172, and when not in use, the user covers the jack cover 170 so as not to expose the jack 172.

The assembly process of the front case to the image photographing apparatus according to an embodiment of the present invention and operation thereof will be described in greater detail with reference to the accompanying drawings.

First, the blocking board 150 is attached to the front side 110a of the housing 110. The hood holder 130 is inserted in the first lens hood 120. At this time, the hole 122 of the first lens hood 120 preferably connects a plurality of tap holes 132 of the hood holder 130. Then, the hood holder 130 is placed over the first hole 111 to meet the tap holes 132 of the hood holder 130. Furthermore, the bolt hole 113 around the first hole 111 of the housing 110, and the hood holder 130 is fixed to the housing 110 by the bolt 115. Lastly, the fixing part 142 of the second lens hood 140 is placed among the protrusion parts 114 of the second hole 112. The second lens hood 140 is inserted in the second hole 112, and the second lens hood 140 is rotated a predetermined distance. The protrusion parts 114 of the second hole 112 are inserted into the fixing groove 143 of the fixing part 142 of the second lens hood 140 so that the second lens hood 140 is fixed on the housing 110. By the above assembly process, the first and second lens hoods 120 and 140, and the blocking board 150 are attached to the housing. The front case 100 of the image photographing apparatus is now complete. When the connecting parts 118 of the housing 110 of the assembled front case 100 are attached to a fixing opening of the main body case 200 as shown in FIG. 4, the image photographing apparatus is completely assembled. The image photographing apparatus is exemplary of an image photographing apparatus assembled by the front case 100.

Since, as described above, hoods for camera lens and camcorder lens are attached to the integral-formed front case, an image photographing apparatus can be minimized in size.

Additionally, since a plurality of sensors for an image photographing apparatus are fixed between two lens holes of the front case, an image photographing apparatus can be further minimized in size.

While the invention has been shown and described with reference to certain embodiments thereof, it will be understood by those skilled in the art that various changes in form and details may be made therein without departing from the spirit and scope of the invention as defined by the appended claims.

1. A front case of an image photographing apparatus which has a main body case receiving a first camera part having a first lens for photographing a moving image and a second camera part having a second lens for photographing a still image, the front case comprising:
a housing assembled to a front side of the main body case; and
a first hole and a second hole formed on the housing front side to expose the first lens and second lens.

2. The front case according to claim 1, wherein
a first lens hood and a second lens hood are assembled to the first and second holes, respectively.

3. The front case according to claim 2, wherein
the first lens is exposed through the first hole, and the second lens is exposed through the second hole.

4. The front case according to claim 3, wherein
the first lens hood assembled to the first hole further comprises a hood holder.

5. The front case according to claim 1, wherein
a sensor receiving part is formed between the first hole and the second hole on a front side of the housing.

6. The front case according to claim 5, wherein
a blocking board is located on the sensor receiving part of the housing to cover the sensor receiving part.

7. The front case according to claim 5, wherein
the sensor receiving part is arranged to house an infrared ray LED, an illumination sensor, an auxiliary illumination LED and a remote control sensor.

8. The front case according to claim 1, wherein
a jack cover is openly formed on one side of the housing to expose a jack installed on the housing.

9. A front case of an image photographing apparatus which has a main body case receiving a first camera part having a first lens for photographing a moving image and a second camera part having a second lens for photographing a still image, the front case comprising:
a housing assembled to a front side of the main body case; and
a first hole and a second hole formed on the housing front side to expose the first lens and second lens; and
a first lens hood and a second lens hood are assembled to the first and second holes, respectively, and the first lens hood includes a hood holder.

10. The front case according to claim 9, wherein
the first lens is exposed through the first hole, and the second lens is exposed through the second hole.

11. The front case according to claim 9, wherein
a sensor receiving part is formed between the first hole and the second hole on a front side of the housing.

12. The front case according to claim 11, wherein
a blocking board is located on the sensor receiving part of the housing to cover the sensor receiving part.

13. The front case according to claim 11, wherein
the sensor receiving part is arranged to house an infrared ray LED, an illumination sensor, an auxiliary illumination LED and a remote control sensor.

14. The front case according to claim 9, wherein
a jack cover is openably formed on one side of the housing to expose a jack installed on the housing.
